(19) United States
(12) Patent Application Publication
(10) Pub. No.: US 2025/0365542 A1
(43) Pub. Date: Nov. 27, 2025

(54) TRANSDUCER

(71) Applicant: Murata Manufacturing Co., Ltd., Nagaokakyo-shi (JP)

(72) Inventors: Shinsuke IKEUCHI, Nagaokakyo-shi (JP); Ryosuke NIWA, Nagaokakyo-shi (JP); Gou SAITOU, Nagaokakyo-shi (JP); Hiroshi MATSUBARA, Nagaokakyo-shi (JP)

(21) Appl. No.: 19/290,546

(22) Filed: Aug. 5, 2025

Related U.S. Application Data
(63) Continuation of application No. PCT/JP2023/043562, filed on Dec. 6, 2023.

(30) Foreign Application Priority Data
Apr. 6, 2023 (JP) 2023-062150

(51) Int. Cl. H04R 17/02; H04R 17/10

(52) U.S. Cl. CPC H04R 17/02; H04R 17/10

(57) ABSTRACT

A transducer that includes: a base portion; a plurality of beam portions each having a fixed end portion connected to the base portion and a crest portion located close to a center of the base portion on a side thereof opposite to the fixed end portion, the plurality of beam portions each extending from the fixed end portion toward the crest portion; and a connection portion that connects a pair of beam portions of the plurality of beam portions to each other, the pair of beam portions being adjacent to each other in a peripheral direction of the base portion, wherein the connection portion includes: at least one bent portion, and at least one dividing slit in the connection portion, the at least one dividing slit dividing the connection portion such that the connection portion is partially branched and rejoined.

### CROSS REFERENCE TO RELATED APPLICATIONS

The present application is a continuation of International application No. PCT/JP2023/043562, filed Dec. 6, 2023, which claims priority to Japanese Patent Application No. 2023-062150, filed Apr. 6, 2023, the entire contents of each of which are incorporated herein by reference.

### TECHNICAL FIELD

The present disclosure relates to a transducer and particularly to an acoustic transducer that can be used as a transmitter for emitting sound waves and as a sound wave receiver (microphone) for receiving sound waves. More particularly, the present disclosure relates to an ultrasonic transceiver capable of transmitting and receiving ultrasonic waves.

### BACKGROUND ART

One document that discloses the structure of a transducer is International Publication No. 2022/049944 (Patent Document 1). The transducer described in Patent Document 1 includes a base portion, a plurality of beam portions, and a connection portion. Each of the plurality of beam portions has a fixed end portion connected to the base portion and a crest portion located on a side opposite to the fixed end portion, and each of the plurality of beam portions extends from the fixed end portion toward the crest portion. The connection portion connects, to each other, a pair of beam portions adjacent to each other in a perimeter direction of the base portion of the plurality of beam portions. Each of the plurality of beam portions is a piezoelectric vibrating portion including a plurality of layers. A slit and a cavity are provided between the pair of beam portions described above. The slit is formed by portions of a pair of adjacent edge portions of the pair of beam portions described above. The cavity is located adjacent to the crest portions of the pair of beam portions while being spaced apart from the slit and is formed of other portions of the pair of edge portions described above. The connection portion is provided so as to be turned around between the pair of beam portions described above. The connection portion includes a first coupling portion, a second coupling portion, and a bridging portion. The first coupling portion extends along the slit and is connected to one of the pair of beam portions. The second coupling portion extends along the slit and is connected to the other of the pair of beam portions. The bridging portion is located between the slit and the cavity and is connected to the first coupling portion and the second coupling portion. Each of the plurality of beam portions is located between slits that extend in directions that intersect with each other and is connected to each other in the perimeter direction via the connection portion.

### SUMMARY OF THE DISCLOSURE

The transducer disclosed in Patent Document 1 is required to suppress the vibration deviations of the plurality of beam portions while the stress in an in-plane direction of a connection portion is relieved by the connection portion and the vibrations of the beam portions are not excessively hindered. The rigidity of the connection portion in the in-plane direction and the rigidity of the connection portion in the thickness direction need to be adjusted as appropriate to satisfy these requirements. However, since the range of the adjustment of the rigidity in the in-plane direction and the rigidity in the thickness direction is limited by the adjustment of only the dimensions of the connection portion, there is room to enable the adjustment of the rigidity of the connection portion in the in-plane direction and the rigidity of the connection portion in the thickness direction.

The present disclosure addresses the problem described above with an object of providing a transducer that enables the adjustment of the rigidity in the in-plane direction (XY direction) and the rigidity in the thickness direction (Z-axis direction) of the connection portion as appropriate and can effectively suppress the vibration deviations of the plurality of beam portions while the stress in the in-plane direction of the connection portion is relieved by the connection portion and the vibrations of the beam portions are not excessively hindered.

A transducer according to the present disclosure includes: a base portion; a plurality of beam portions each having a fixed end portion connected to the base portion and a crest portion located close to a center of the base portion on a side thereof opposite to the fixed end portion, the plurality of beam portions each extending from the fixed end portion toward the crest portion; and a connection portion that connects a pair of beam portions of the plurality of beam portions to each other, the pair of beam portions being adjacent to each other in a peripheral direction of the base portion, wherein the connection portion includes: at least one bent portion, and at least one dividing slit in the connection portion, the at least one dividing slit dividing the connection portion such that the connection portion is partially branched and rejoined.

According to the present disclosure, by enabling the adjustment of the rigidity in the in-plane direction and the rigidity in the thickness direction of the connection portion as appropriate, the vibration deviations of the plurality of beam portions can be effectively suppressed while the stress in the in-plane direction of the connection portion is relieved by the connection portion and the vibrations of the beam portions are not excessively hindered.

### BRIEF DESCRIPTION OF THE DRAWINGS

FIG. 1 is a plan view of a transducer according to embodiment 1 of the present disclosure.

FIG. 2 is a cross-sectional view of the transducer in FIG. 1 as viewed in the direction of arrows II-II.

FIG. 3 is a partial plan view illustrating a portion indicated by III in FIG. 1 in an enlarged manner.

FIG. 4 is a cross-sectional view schematically illustrating a portion of a beam portion of the transducer according to embodiment 1 of the present disclosure.

FIG. 5 is a cross-sectional view schematically illustrating a portion of the beam portion of the transducer according to embodiment 1 of the present disclosure when the transducer is being driven.

FIG. 6 is a perspective view illustrating, in simulation, a state in which the transducer according to embodiment 1 of the present disclosure is vibrating in a fundamental vibration mode.

FIG. 7 is a plan view illustrating the extension length, the shortest distance between the crest portion and the central axis, and the length of the fixed end portion of each of a plurality of beam portions of the transducer according to embodiment 1 of the present disclosure.

FIG. 8 is a cross-sectional view illustrating a state in which a second electrode layer has been provided on a piezoelectric single-crystal substrate in a manufacturing method of the transducer according to embodiment 1 of the present disclosure.

FIG. 9 is a cross-sectional view illustrating a state in which a first support portion has been provided in the manufacturing method of the transducer according to embodiment 1 of the present disclosure.

FIG. 10 is a cross-sectional view illustrating a state in which a multilayer body has been joined to the first support portion in the manufacturing method of the transducer according to embodiment 1 of the present disclosure.

FIG. 11 is a cross-sectional view illustrating a state in which a piezoelectric body layer is formed by a piezoelectric single-crystal substrate being ground in the manufacturing method of the transducer according to embodiment 1 of the present disclosure.

FIG. 12 is a cross-sectional view illustrating a state in which a first electrode layer has been provided on the piezoelectric body layer in the manufacturing method of the transducer according to embodiment 1 of the present disclosure.

FIG. 13 is a cross-sectional view illustrating a state in which a groove portion and a recessed portion have been provided in the manufacturing method of the transducer according to embodiment 1 of the present disclosure.

FIG. 14 is a partial cross-sectional view illustrating a state in which a first connection electrode layer and a second electrode connection layer have been provided in the manufacturing method of the transducer according to embodiment 1 of the present disclosure.

FIG. 15 is a diagram for describing a state in which a load in an in-plane direction is applied to one end of a turn-around portion of a connection portion according to a comparative example and deformation occurs.

FIG. 16 is a diagram for describing a state in which a load in the in-plane direction is applied to one end of a turn-around portion of a connection portion according to an example and deformation occurs.

FIG. 17 is a diagram illustrating the distribution of an internal stress generated in the state which a load in the in-plane direction is applied to one end of the turn-around portion of the connection portion according to the comparative example and deformation has occurred.

FIG. 18 is a diagram illustrating the distribution of an internal stress generated in a state in which a load in the in-plane direction is applied to one end of the turn-around portion of the connection portion according to the example and deformation has occurred.

FIG. 19 is a diagram for describing a state in which a load in a thickness direction is applied to one end of the turn-around portion of the connection portion according to the comparative example and deformation occurs.

FIG. 20 is a diagram for describing a state in which a load in the thickness direction is applied to one end of the turn-around portion of the connection portion according to the example and deformation occurs.

FIG. 21 is a diagram illustrating the distribution of an internal stress generated in a state in which a load in the thickness direction is applied to one end of the turn-around portion of the connection portion according to the comparative example and deformation occurs.

FIG. 22 is a diagram illustrating the distribution of an internal stress generated in a state in which a load in the thickness direction is applied to one end of the turn-around portion of the connection portion according to the example and deformation occurs.

FIG. 23 is a diagram for describing the distributions of internal stresses generated in the turn-around portions of the connection portions according to the comparative example and the example.

FIG. 24 is a graph illustrating changes in maximum principal stresses with respect to the distance from point S at the root of portion R on line A.

FIG. 25 is a plan view illustrating, in an enlarged manner, a portion of the connection portion including a second elastic body layer that functions as a lower electrode layer and the piezoelectric body layer.

FIG. 26 is a cross-sectional view of the connection portion in FIG. 25 as viewed in an XXVI-XXVI direction.

FIG. 27 is a plan view illustrating a portion of the connection portion including only the second elastic body layer in an enlarged manner.

FIG. 28 is a cross-sectional view of the connection portion in FIG. 27 as viewed in an XXVIII-XXVIII direction.

FIG. 29 is a plan view of a transducer according to a first modification of embodiment 1 of the present disclosure.

FIG. 30 is a plan view of a transducer according to a second modification of embodiment 1 of the present disclosure.

FIG. 31 is a plan view of a transducer according to a third modification of embodiment 1 of the present disclosure.

FIG. 32 is a plan view of a transducer according to a fourth modification of embodiment 1 of the present disclosure.

FIG. 33 is a plan view of a transducer according to a fifth modification of embodiment 1 of the present disclosure.

FIG. 34 is a plan view of a transducer according to a sixth modification of embodiment 1 of the present disclosure.

FIG. 35 is a plan view of a transducer according to embodiment 2 of the present disclosure.

FIG. 36 is a plan view of a transducer according to a modification of embodiment 2 of the present disclosure.

FIG. 37 is a cross-sectional view of a transducer according to embodiment 3 of the present disclosure.

FIG. 38 is a cross-sectional view illustrating a state in which the multilayer body has been joined to the first support portion in a manufacturing method of the transducer according to embodiment 2 of the present disclosure.

FIG. 39 is a cross-sectional view of a transducer according to a modification of embodiment 3 of the present disclosure.

### DESCRIPTION OF THE PREFERRED EMBODIMENTS

Transducers according to embodiments of the present disclosure will be described below with reference to the drawings. In the descriptions of the embodiments below, the same or corresponding portions in the drawings are denoted by the same reference numerals, and the descriptions thereof will not be repeated. It should be noted that, in the following description, the center of a base portion 110 refers to a position that includes a central axis C of the base portion 110, which will be described later, and the vicinity of the central axis C.

### Embodiment 1

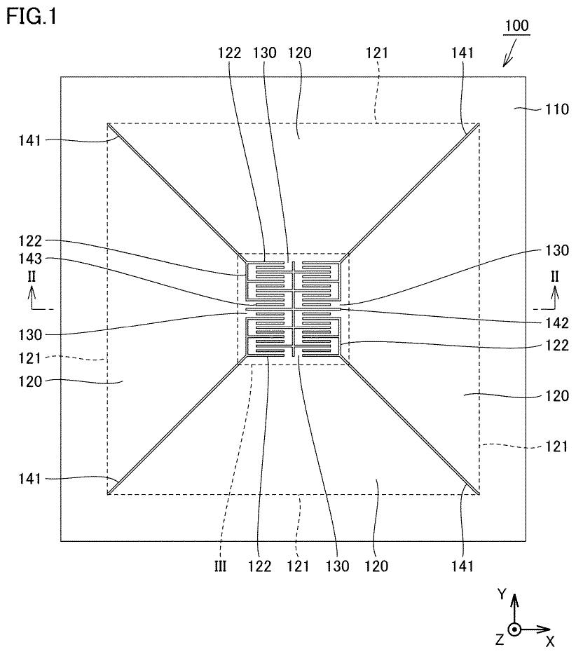

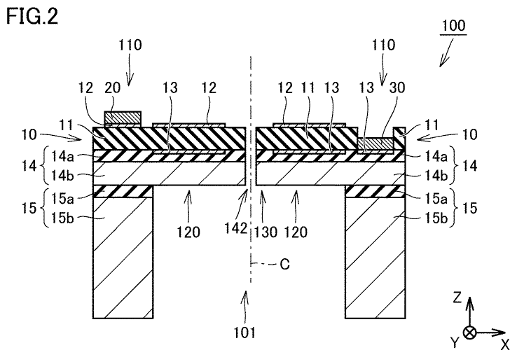

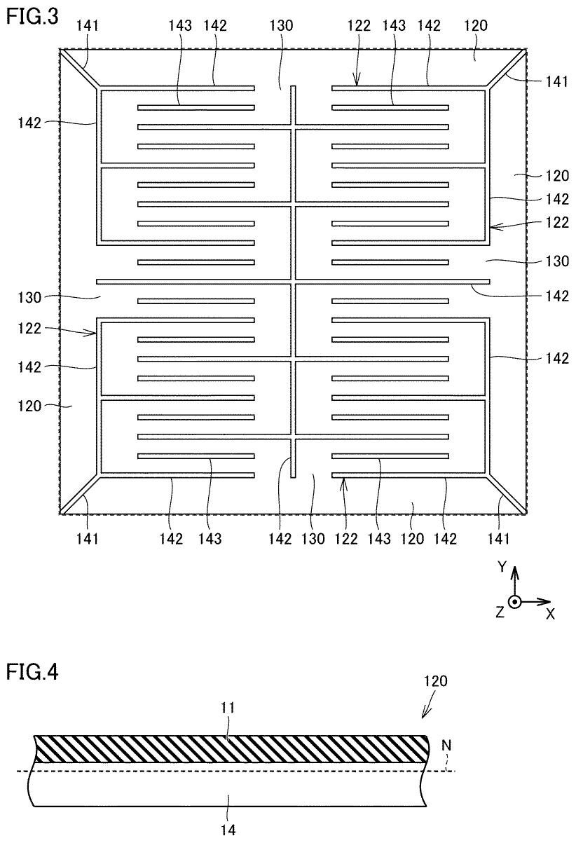

FIG. 1 is a plan view of a transducer according to embodiment 1 of the present disclosure. FIG. 2 is a cross-sectional view of the transducer in FIG. 1 as viewed in the direction of arrows II-II. FIG. 3 is a partial plan view illustrating a portion indicated by III in FIG. 1 in an enlarged manner. In FIGS. 1 and 3, individual electrode layers are not illustrated for simplicity.

As illustrated in FIGS. 1 to 3, a transducer 100 according to embodiment 1 of the present disclosure includes a base portion 110, a plurality of beam portions 120, and a connection portion 130. In the embodiment, the transducer 100 includes four beam portions 120. However, the number of beam portions 120 is not limited to four as long as it is two or more. The transducer 100 according to the embodiment can be used as an ultrasonic transducer because the plurality of beam portions 120 can be subjected to bending vibration.

In the embodiment, the base portion 110 has a square frame shape extending in an X-axis direction and a Y-axis direction as viewed in the axial direction of the central axis C illustrated in FIG. 2. It should be noted that the shape of the base portion 110 is not particularly limited as long as it is a frame shape as viewed in the central axis direction (Z-axis direction). As viewed in the central axis direction (Z-axis direction), the outer peripheral surface of the base portion 110 may also be polygonal or circular, and the inner peripheral surface of the base portion 110 may also be polygonal or circular. For example, the length dimension of one side of the inner peripheral surface of the base portion 110 is 0.6 mm to 1.5 mm, and the thickness dimension of the base portion 110 is 0.2 mm to 0.5 mm.

As illustrated in FIG. 2, the base portion 110 includes a support layer 15. A cavity 101 is formed in the support layer 15. A vibration layer 10 is disposed above the support layer 15. The base portion 110 further includes a portion located above the support layer 15 in the vibration layer 10, and a first connection electrode layer 20 and a second connection electrode layer 30 that are disposed above this portion.

The support layer 15 includes a middle layer 15a and a substrate layer 15b. The middle layer 15a is formed on the substrate layer 15b. In the embodiment, the middle layer 15a includes SiO₂, and the substrate layer 15b includes a single-crystal Si. It should be noted that the materials of the middle layer 15a and the substrate layer 15b are not limited to Si and may be other semiconductor materials.

The vibration layer 10 includes a piezoelectric body layer 11, a first electrode layer 12, a second electrode layer 13, and an elastic body layer 14. The thickness dimension of the vibration layer 10 is, for example, 0.5 μm to 6.0 μm.

The piezoelectric body layer 11 includes a single-crystal piezoelectric body. The cutting orientation of the piezoelectric body layer 11 is selected as appropriate to exhibit desired device characteristics. In the embodiment, the piezoelectric body layer 11 is a thinned single-crystal substrate, and the single-crystal substrate is specifically a rotated Y-cut substrate. The cutting orientation of the rotated Y-cut substrate is specifically 30°. The thickness dimension of the piezoelectric body layer 11 is, for example, 0.3 μm to 5.0 μm.

The material constituting the piezoelectric body layer 11 is selected as appropriate such that the transducer 100 exhibits desired device characteristics. In the embodiment, the piezoelectric body layer 11 includes an inorganic material. Specifically, the piezoelectric body layer 11 includes an alkali niobate compound or an alkali tantalate compound. In the embodiment, the alkali metal contained in the niobium alkali-based compound or the tantalum alkali-based compound is at least one of lithium, sodium, and potassium. In the embodiment, the piezoelectric body layer 11 includes lithium niobate (LiNbO₃) or lithium tantalate (LiTaO₃).

As illustrated in FIG. 2, the first electrode layer 12 is disposed above the piezoelectric body layer 11. The second electrode layer 13 is disposed below the piezoelectric body layer 11 so as to face at least a portion of the first electrode layer 12 with the piezoelectric body layer 11 therebetween. In the embodiment, close contact layers, which are not illustrated, are provided between the first electrode layer 12 and the piezoelectric body layer 11 and between the second electrode layer 13 and the piezoelectric body layer 11.

In the embodiment, the first electrode layer 12 and the second electrode layer 13 include Pt. The first electrode layer 12 and the second electrode layer 13 may also include other materials, such as Al. The close contact layer includes Ti. The close contact layer may also include other materials, such as NiCr alloy. The first electrode layer 12, the second electrode layer 13, and the close contact layer may also be epitaxially grown films. When the piezoelectric body layer 11 includes lithium niobate (LiNbO₃), the close contact layer preferably includes NiCr alloy to suppress the material constituting the close contact layer from diffusing to the first electrode layer 12 or the second electrode layer 13. This can improve the reliability of the transducer 100.

In the embodiment, the dimensions of the first electrode layer 12 and the second electrode layer 13 are, for example, 0.05 μm to 0.2 μm. The thickness dimension of the close contact layer is, for example, 0.005 μm to 0.05 μm.

The elastic body layer 14 is disposed on a side of the piezoelectric body layer 11 opposite to the first electrode layer 12 and on a side of the second electrode layer 13 opposite to the piezoelectric body layer 11. The elastic body layer 14 includes a first elastic body layer 14a and a second elastic body layer 14b that is laminated on a side of the first elastic body layer 14a opposite to the piezoelectric body layer 11. In the embodiment, the first elastic body layer 14a includes SiO₂, and the second elastic body layer 14b includes single-crystal Si. In the embodiment, the thickness of the elastic body layer 14 is preferably greater than that of the piezoelectric body layer 11 in terms of the bending vibrations of the plurality of beam portions 120. It should be noted that the mechanism of the bending vibrations of the plurality of beam portions 120 will be described later.

As illustrated in FIG. 2, the first connection electrode layer 20 is formed on the first electrode layer 12 via a close contact layer, which is not illustrated. The second connection electrode layer 30 is formed on the second electrode layer 13 via a close contact layer, which is not illustrated.

The thickness dimensions of the first connection electrode layer 20 and the second connection electrode layer 30 are, for example, 0.1 μm to 1.0 μm. The thickness dimensions of the close contact layer of the first connection electrode layer 20 and the second connection electrode layer 30 are, for example, 0.005 μm to 0.1 μm.

In the embodiment, the first connection electrode layer 20 and the second connection electrode layer 30 include Au. The first connection electrode layer 20 and the second connection electrode layer 30 may include other conductive materials, such as Al. The close contact layer connected to the first connection electrode layer 20 and the close contact layer connected to the second connection electrode layer 30 include, for example, Ti. These close contact layers may include NiCr alloy.

As illustrated in FIGS. 1 to 3, as viewed in the central axis direction (Z-axis direction), first slits 141 and second slits 142, which are connected to each other, are formed in a portion located inside the base portion 110 in the vibration layer 10. The first slits 141 extend from the corner portions of the inner peripheral side surfaces of the base portion 110 toward the center of the base portion 110 as viewed in the central axis direction (Z-axis direction). In the embodiment, the second slit 142 is formed in a comb-like shape.

As viewed in the central axis direction (Z-axis direction), the width dimensions of the first slits 141 and the second slits 142 are preferably 10 μm or less to suppress sound leakage through the slits. In addition, the width dimensions of the first slits 141 and the second slits 142 may preferably be 3 μm or more to lower the Q value at the resonant frequency of the transducer 100.

Since the first slits 141 and the second slits 142 that pass through the vibration layer 10 are formed in the portion located inside the base portion 110 in the vibration layer 10, the plurality of beam portions 120 and at least one connection portion 130 are formed.

As illustrated in FIG. 1, each of the plurality of beam portions 120 has a fixed end portion 121 connected to the base portion 110 and a crest portion 122 located close to the center of the base portion 110 on a side opposite to the fixed end portion 121, and extends from the fixed end portion 121 to the crest portion 122. As illustrated in FIG. 2, the plurality of beam portions 120 are located so as to cover the cavity 101. The plurality of beam portions 120 extend along the same virtual plane in a state in which the transducer 100 is not driven.

As illustrated in FIG. 1, the plurality of beam portions 120 extend from the periphery of the base portion 110 toward the center of the base portion 110 and are adjacent to each other in the peripheral direction of the base portion 110. In the embodiment, the plurality of beam portions 120 are formed to be rotationally symmetrical with respect to the central axis C of the base portion 110 as viewed in the central axis direction (Z-axis direction).

The plurality of beam portions 120 have a tapered outer shape as viewed in the central axis direction (Z-axis direction). Specifically, the plurality of beam portions 120 have an outer shape of substantially an isosceles trapezoid as viewed in the central axis direction (Z-axis direction). The fixed end portions 121 of the plurality of beam portions 120 are connected to a plurality of sides of the inner peripheral surface of the base portion 110 and are located in a one-to-one correspondence with the plurality of sides of the inner peripheral surface of the base portion 110 as viewed in the central axis direction (Z-axis direction). For example, as viewed in the central axis direction (Z-axis direction), the length dimension of the fixed end portion 121 is 0.5 mm to 1.5 mm.

As illustrated in FIG. 2, each of the plurality of beam portions 120 is a vibrating portion that includes the piezoelectric body layer 11. Specifically, each of the plurality of beam portions 120 includes a portion of the vibration layer 10, located inside the base portion 110 as viewed in the central axis direction (Z-axis direction), that is not the connection portion 130.

The plurality of beam portions 120 can vibrate when a voltage is applied to the piezoelectric body layer 11. In addition, the plurality of beam portions 120 can detect vibrations by converting the vibrations acting on the plurality of beam portions 120 into a voltage through the piezoelectric body layer 11. It should be noted that the structure of the plurality of beam portions 120 is not limited to the structure that generates and detects vibrations by a piezoelectric method as described above and may also be the structure that generates and detects vibrations by an electrostatic method.

The length dimensions of the plurality of beam portions 120 in the extension direction are preferably at least five times greater than the thickness dimensions of the plurality of beam portions 120 in the central axis direction (Z-axis direction) to facilitate bending vibration. It should be noted that in FIG. 2, the extension lengths and the thicknesses of the plurality of beam portions 120 are illustrated schematically and do not represent actual proportions.

As illustrated in FIG. 1, a pair of beam portions 120 adjacent to each other in the peripheral direction of the base portion 110 of the plurality of beam portions 120 are connected to each other by the connection portion 130. In the embodiment, the crest portions 122 of the pair of beam portions 120 are connected to each other by a connection portion 130. Each of the plurality of beam portions 120 is connected at one location to one connection portion 130.

The connection portion 130 includes at least one bent portion. A bent portion is a portion at which the extension direction of the connection portion 130 changes by approximately 90°. In the embodiment, the connection portion 130 with a meandering shape includes a plurality of turn-around portions. Each of the turn-around portions includes two bent portions. It should be noted that the bent portion may be curved. In this case, the turn-around portion is formed in a C shape.

As illustrated in FIGS. 1 and 3, the connection portion 130 has at least one dividing slit 143 that divides the connection portion 130 such that the connection portion 130 is partially branched and rejoined. The dividing slit 143 passes through the connection portion 130 in the thickness direction (Z-axis direction) of the connection portion 130 and partially branches the connection portion 130 in the in-plane direction. The dividing slit 143 divides, substantially evenly, the portion of the connection portion 130 that the dividing slit 143 partially branches.

In the embodiment, the dividing slit 143 is formed in a linear extension portion adjacent to the bent portion in the connection portion 130, and the linear extension portion is branched into two. The linear extension portion is divided by the dividing slit 143 such that the width thereof is divided into two halves. The width dimension of the dividing slit 143 is preferably 10 μm or less to suppress sound leakage through the dividing slit 143.

As illustrated in FIG. 2, in the embodiment, the vibration layers 10 that constitute each of the plurality of beam portions 120 are continuously provided in a direction orthogonal to the lamination direction to form the connection portion 130. In the embodiment, the vibration layer 10 of the connection portion 130 does not include the first electrode layer 12 or the second electrode layer 13. However, the vibration layer 10 of the connection portion 130 may include the first electrode layer 12 and the second electrode layer 13. It should be noted that, when the second elastic body layer 14b includes low-resistance Si, the second elastic body layer 14b can function as the lower electrode layer without the second electrode layer 13 being provided and, in this case, the first elastic body layer 14a is not provided, and the vibration layer 10 of the connection portion 130 includes the lower electrode layer including the second elastic body layer 14b.

Here, the mechanism of bending vibrations of the plurality of beam portions 120 will be described.

FIG. 4 is a cross-sectional view schematically illustrating a portion of the beam portion of the transducer according to embodiment 1 of the present disclosure. FIG. 5 is a cross-sectional view schematically illustrating the portion of the beam portion of the transducer according to embodiment 1 of the present disclosure when the transducer is being driven. It should be noted that the first electrode layer and the second electrode layer are not illustrated in FIGS. 4 and 5.

As illustrated in FIGS. 4 and 5, in the embodiment, in the plurality of beam portions 120, the piezoelectric body layer 11 functions as a stretch layer that can expand and contract in the in-plane direction (XY direction) orthogonal to the thickness direction (Z-axis direction) of the connection portion 130, and layers other than the piezoelectric body layer 11 function as restriction layers. In the embodiment, the elastic body layer 14 mainly functions as a restriction layer. As described above, the restriction layer is laminated on the stretch layer in a direction orthogonal to the stretching direction of the stretch layer. It should be noted that the plurality of beam portions 120 may include a reverse direction stretch layer that contracts in the in-plane direction when the stretch layer extends in the in-plane direction and extends in the in-plane direction when the stretch layer contracts in the in-plane direction, instead of a restriction layer.

In addition, when the piezoelectric body layer 11, which is the stretch layer, attempts to expand and contract in the in-plane direction, the elastic body layer 14, which is a main portion of the restriction layer, restrains the expansion and contraction of the piezoelectric body layer 11 at the joint surface with the piezoelectric body layer 11. In addition, in the embodiment, in each of the plurality of beam portions 120, the piezoelectric body layer 11, which is a stretch layer, is located only on one side of a stress neutral plane N of each of the plurality of beam portions 120. The position of the gravity center of the elastic body layer 14 that mainly constitutes the restriction layer is located on the other side of the stress neutral plane N. As a result, as illustrated in FIGS. 4 and 5, when the piezoelectric body layer 11, which is a stretch layer, expands and contracts in the in-plane direction, the plurality of beam portions 120 are bent in a direction (Z-axis direction) orthogonal to the in-plane direction. It should be noted that the amount of displacement of each of the plurality of beam portions 120 when each of the plurality of beam portions 120 is bent increases as the separation distance between the stress neutral plane N and the piezoelectric body layer 11 is larger. In addition, the amount of displacement described above increases as the stress when the piezoelectric body layer 11 expands or contracts is greater. As described above, the plurality of beam portions 120 are subjected to bending vibration in a direction orthogonal to the in-plane direction, starting from the fixed end portion 121.

In addition, in the transducer 100 according to the embodiment, the presence of the connection portion 130 facilitates the occurrence of vibration in a fundamental vibration mode and suppresses the occurrence of vibrations in a coupled vibration mode. In the fundamental vibration mode, phases are aligned when the plurality of beam portions 120 are subjected to bending vibration, and the entire beam portions 120 displace either upward or downward. On the other hand, in the coupled vibration mode, when the plurality of beam portions 120 are subjected to bending vibration, the phase of at least one of the plurality of beam portions 120 is not aligned with the phases of the other beam portions 120.

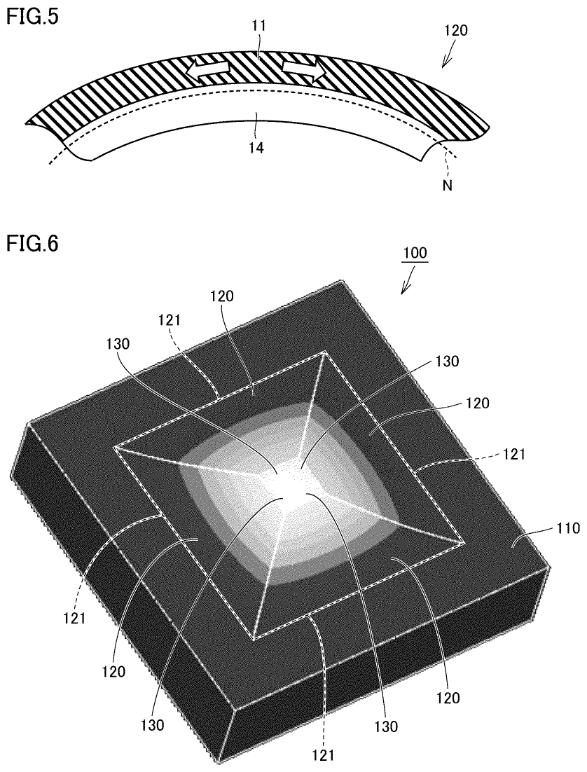

FIG. 6 is a perspective view illustrating, in simulation, a state in which the transducer according to embodiment 1 of the present disclosure is vibrating in the fundamental vibration mode. Specifically, FIG. 6 illustrates the transducer 100 in a state in which the plurality of beam portions 120 have displaced toward the first electrode layer 12. In addition, in FIG. 6, the color becomes lighter as the amount of displacement of the plurality of beam portions 120 toward the first electrode layer 12 is greater.

Since adjacent beam portions of the plurality of beam portions 120 are connected to each other by the connection portion 130 as illustrated in FIG. 6, the occurrence of the coupled vibration mode is suppressed. Since the plurality of beam portions 120 are connected to each other at the crest portions thereof as described above, the coupled vibration mode is less likely to occur.

In addition, since each of the connection portions 130 of the transducer 100 according to the embodiment has a meandering shape, the connection portion 130 functions like a leaf spring when the plurality of beam portions 120 vibrate, the length of the connection portion 130 as a leaf spring increases while the connection portion 130 connects adjacent beam portions to each other, and accordingly, the connection portion 130 can suppress the connecting force from being strengthened excessively.

Since vibration in the fundamental vibration mode easily occurs and the occurrence of the coupled vibration mode is suppressed in the transducer 100 according to the embodiment, the device characteristics when used as an ultrasonic transducer is particularly improved. The function and operation of the transducer 100 when the transducer 100 according to the embodiment is used as an ultrasonic transducer will be described below.

First, when ultrasonic waves are generated by the transducer 100, a voltage is applied between the first connection electrode layer 20 and the second connection electrode layer 30 that are illustrated in FIG. 2. The voltage is applied between the first electrode layer 12 connected to the first connection electrode layer 20 and the second electrode layer 13 connected to the second connection electrode layer 30. In addition, the voltage is also applied between the first electrode layer 12 and the second electrode layer 13 that face each other via the piezoelectric body layer 11 for each of the plurality of beam portions 120. In this case, since the piezoelectric body layer 11 expands and contracts in the in-plane direction orthogonal to the thickness direction (Z-axis direction) of the connection portion 130, the plurality of beam portions 120 are subjected to bending vibration in the thickness direction (Z-axis direction) of the connection portion 130 due to the mechanism described above. As a result, since a force is applied to the medium surrounding the plurality of beam portions 120 of the transducer 100 and the medium vibrates, ultrasonic waves are generated.

In the transducer 100 according to the embodiment, each of the plurality of beam portions 120 has a unique mechanical resonant frequency. Accordingly, when the applied voltage is a sinusoidal voltage and the frequency of the sinusoidal voltage is close to the value of the resonant frequency described above, the amount of displacement when each of the plurality of beam portions 120 is bent increases.

When ultrasonic waves are detected by the transducer 100, the media surrounding the plurality of beam portions 120 vibrate due to the ultrasonic waves, forces are applied to the plurality of beam portions 120 by the surrounding media, and the plurality of beam portions 120 are subjected to bending vibration. When the plurality of beam portions 120 are subjected to bending vibration, a stress is applied to the piezoelectric body layer 11. When the stress is applied to the piezoelectric body layer 11, an electric charge is induced within the piezoelectric body layer 11. A potential difference is generated between the first electrode layer 12 and the second electrode layer 13 that face each other with the piezoelectric body layer 11 therebetween due to the electric charge induced in the piezoelectric body layer 11. This potential difference is detected by the first connection electrode layer 20 connected to the first electrode layer 12 and the second connection electrode layer 30 connected to the second electrode layer 13. As a result, ultrasonic waves can be detected by the transducer 100.

In addition, when the ultrasonic wave to be detected contains a large amount of specific frequency components and the frequency components are close to the value of the resonant frequency described above, the amount of displacement when the plurality of beam portions 120 are subjected to bending vibration increases. As the amount of displacement increases, the potential difference described above becomes larger.

When the transducer 100 according to the embodiment is used as an ultrasonic transducer as described above, the resonant frequencies of the plurality of beam portions 120 are 20 kHz to 60 kHz. When the transducer 100 is used as an audio device, such as a speaker or a microphone, the resonant frequencies of the plurality of beam portions 120 are set to values less than 20 kHz, which are within the audible range.

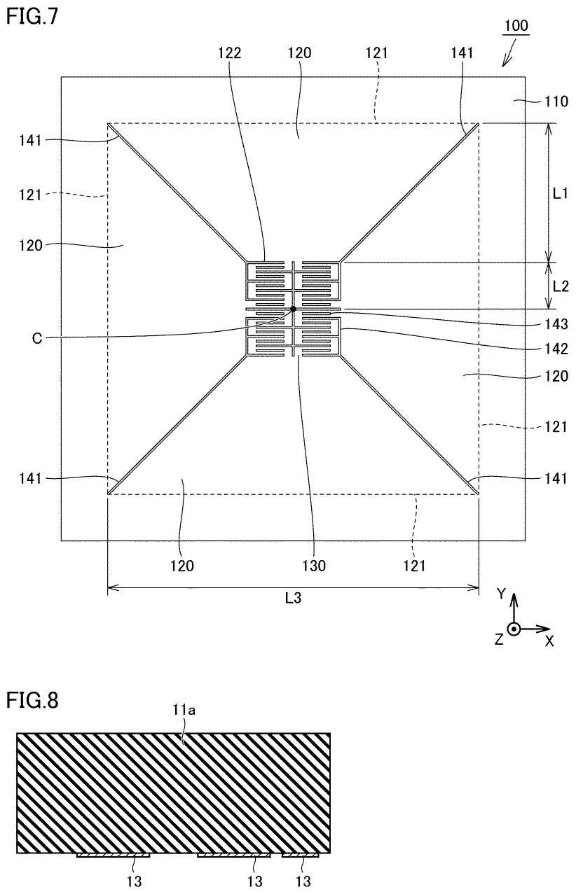

FIG. 7 is a plan view illustrating the extension length, the shortest distance between the crest portion and the central axis, and the length of the fixed end portion of each of the plurality of beam portions of the transducer according to embodiment 1 of the present disclosure. FIG. 7 does not illustrate the individual electrode layers for simplicity. As illustrated in FIG. 7, in the embodiment, when the extension length is L1, the shortest distance between the crest portion 122 and the central axis C is L2, and the length of the fixed end portion 121 is L3 in each of the plurality of beam portions 120, the relationship L3≈2(L1+L2) is satisfied.

The resonant frequencies of the plurality of beam portions 120 in the fundamental vibration mode change depending on the extension length L1, the shortest distance L2 between the crest portion 122 and the central axis C, the length L3 of the fixed end portion 121, the thickness of the central axis C in the axial direction, and the density and the elastic modulus of the material constituting the plurality of beam portions 120 in each of the plurality of beam portions 120.

For example, in the transducer 100 according to embodiment 1 of the present disclosure illustrated in FIGS. 1 to 3, when the resonant frequencies of the plurality of beam portions 120 are set to values closer to 40 kHz, for each of the plurality of beam portions 120, it is sufficient that the material of the piezoelectric body layer 11 is lithium niobate, the thickness dimension of the piezoelectric body layer 11 is 1 μm, the thickness dimensions of the first electrode layer 12 and the second electrode layer 13 are 0.1 μm, the thickness dimension of the first elastic body layer 14a is 0.2 μm, the thickness of the second elastic body layer 14b is 2.0 μm, the extension length L1 of the plurality of beam portions 120 is 316 μm, the shortest distance L2 between the crest portion 122 and the central axis C is 77 μm, and the length L3 of the fixed end portions 121 as viewed in the lamination direction is 786 μm. When the thicknesses of the layers constituting the vibration layer 10 differ from the values described above, the resonant frequencies of the plurality of beam portions 120 in the fundamental vibration mode can be set to desired frequencies by adjusting the extension lengths L1 of the plurality of beam portions 120 as appropriate.

The manufacturing method of the transducer 100 according to embodiment 1 of the present disclosure will be described below. FIG. 8 is a cross-sectional view illustrating a state in which the second electrode layer has been provided on a piezoelectric single-crystal substrate in the manufacturing method of the transducer according to embodiment 1 of the present disclosure. In FIG. 8 and FIGS. 9 to 14 described below, the same cross-sectional view as in FIG. 2 is illustrated.

As illustrated in FIG. 8, first, a close contact layer, which is not illustrated, is provided on the lower surface of a piezoelectric single-crystal substrate 11a, and then a second electrode layer 13 is provided on a side of the close contact layer opposite to the piezoelectric single-crystal substrate 11a. The second electrode layer 13 is formed by a vapor deposition lift-off method so as to have a desired pattern. The second electrode layer 13 may also be formed by performing lamination on the entire lower surface of the piezoelectric single-crystal substrate 11a using sputtering and then by forming a desired pattern using an etching method. The second electrode layer 13 and the close contact layer may be epitaxially grown.

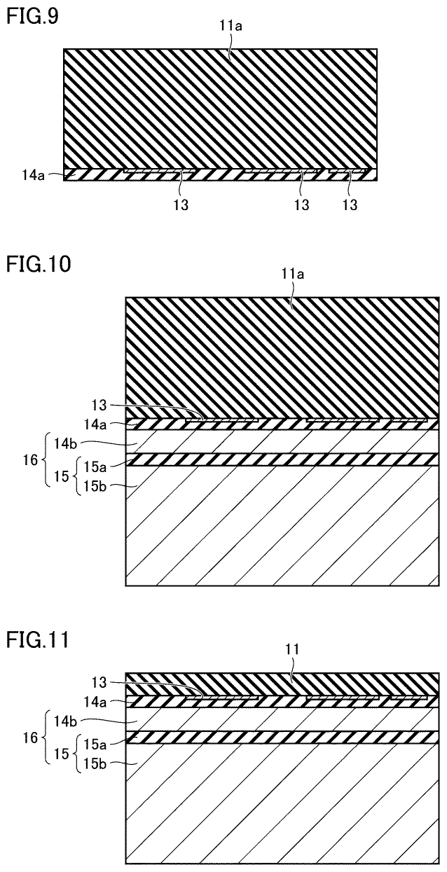

FIG. 9 is a cross-sectional view illustrating a state in which a first support portion has been provided in the manufacturing method of the transducer according to embodiment 1 of the present disclosure. As illustrated in FIG. 9, the first elastic body layer 14a is provided on the lower surfaces of the piezoelectric single-crystal substrate 11a and the second electrode layer 13 by a chemical vapor deposition (CVD) method, a physical vapor deposition (PVD) method, or the like. Immediately after the first elastic body layer 14a is provided, a portion of the lower surface of the first elastic body layer 14a that is located on a side of the first elastic body layer 14a opposite to the second electrode layer 13 is raised. Accordingly, the lower surface of the first elastic body layer 14a is polished and flattened by using a method, such as chemical mechanical polishing (CMP).

FIG. 10 is a cross-sectional view illustrating a state in which a multilayer body has been joined to the first support portion in the manufacturing method of the transducer according to embodiment 1 of the present disclosure. As illustrated in FIG. 10, a multilayer body 16 including the second elastic body layer 14b and the support layer 15 is joined to the lower surface of the first elastic body layer 14a by surface activation bonding or atomic diffusion bonding. In the embodiment, the multilayer body 16 is a silicon-on-insulator (SOI) substrate. It should be noted that the yield of the transducer 100 is improved by the upper surface of the second elastic body layer 14b being flattened in advance by CMP or the like. In addition, when the second elastic body layer 14b is made of Si with low resistance, the second elastic body layer 14b can function as the lower electrode layer, and, in this case, the second electrode layer 13 and the first elastic body layer 14a do not need to be formed.

FIG. 11 is a cross-sectional view illustrating a state in which a piezoelectric body layer is formed by a piezoelectric single-crystal substrate being ground in the manufacturing method of the transducer according to embodiment 1 of the present disclosure. As illustrated in FIG. 11, the upper surface of the piezoelectric single-crystal substrate 11a is ground by a grinder to thin the piezoelectric single-crystal substrate 11a. The thinned upper surface of the piezoelectric single-crystal substrate 11a is further polished by CMP or the like to form the piezoelectric single-crystal substrate 11a into the piezoelectric body layer 11.

It should be noted that a delamination layer may be formed by ions being injected into a portion of the piezoelectric single-crystal substrate 11a close to the upper surface in advance, and the piezoelectric single-crystal substrate 11a may be formed into the piezoelectric body layer 11 by removal of the delamination layer. In addition, the upper surface of the piezoelectric single-crystal substrate 11a after removal of the delamination layer may be further polished by CMP or the like to form the piezoelectric single-crystal substrate 11a into the piezoelectric body layer 11.

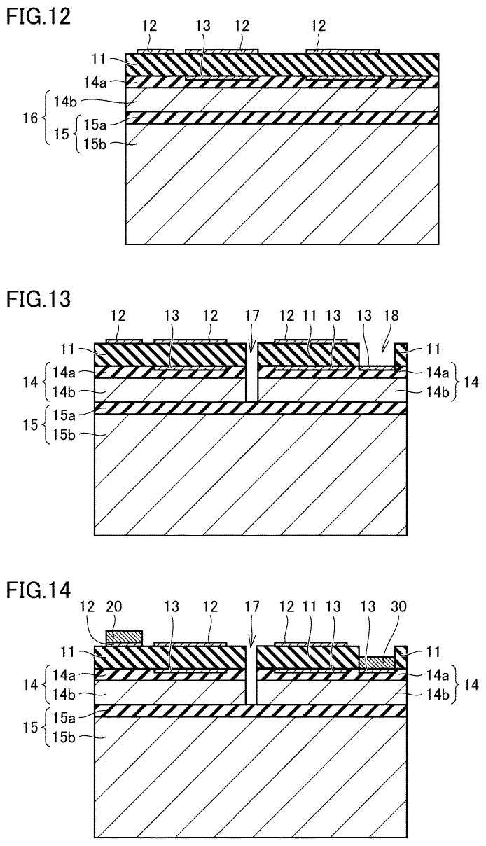

FIG. 12 is a cross-sectional view illustrating a state in which the first electrode layer has been provided on the piezoelectric body layer in the manufacturing method of the transducer according to embodiment 1 of the present disclosure. As illustrated in FIG. 12, a close contact layer, which is not illustrated, is provided on the upper surface of the piezoelectric body layer 11, and then the first electrode layer 12 is provided on a side of the close contact layer opposite to the piezoelectric body layer 11. The first electrode layer 12 is formed by a vapor deposition lift-off method so as to have a desired pattern. The first electrode layer 12 may also be formed by performing lamination on the entire upper surface of the piezoelectric body layer 11 using sputtering and then by forming a desired pattern using an etching method. The first electrode layer 12 and the close contact layer may be epitaxially grown.

FIG. 13 is a cross-sectional view illustrating a state in which a groove portion and a recessed portion have been provided in the manufacturing method of the transducer according to embodiment 1 of the present disclosure. As illustrated in FIG. 13, a slit is formed in the piezoelectric body layer 11 and the first elastic body layer 14a by performing dry etching, such as reactive ion etching (RIE), of the region corresponding to the region inside the base portion 110 of the transducer 100 as viewed in the lamination direction. The slit described above may be formed by wet etching that uses fluonitric acid. In addition, the second elastic body layer 14b exposed to the slit is etched by deep reactive ion etching (DRIE) such that the slit reaches the upper surface of the support layer 15. As a result, the groove portion 17 illustrated in FIG. 13 that corresponds to the first slit 141, the second slit 142, and the dividing slit 143 illustrated in FIGS. 1 and 2 is formed.

In addition, as illustrated in FIG. 13, in the portion corresponding to the base portion 110 of the transducer 100, the piezoelectric body layer 11 is etched such that a portion of the second electrode layer 13 is exposed by using the dry etching or the wet etching described above. As a result, a recessed portion 18 is formed.

FIG. 14 is a partial cross-sectional view illustrating a state in which the first connection electrode layer and the second electrode connection layer have been provided in the manufacturing method of the transducer according to embodiment 1 of the present disclosure. In addition, as illustrated in FIG. 14, in the portion corresponding to the base portion 110, after close contact layers, which are not illustrated, are provided on the first electrode layer 12 and the second electrode layer 13, the first connection electrode layer 20 and the second connection electrode layer 30 are provided on the upper surfaces of the close contact layers by the vapor deposition lift-off method. The first connection electrode layer 20 and the second connection electrode layer 30 may be formed by performing lamination on the entire surfaces of the piezoelectric body layer 11, the first electrode layer 12, and the exposed second electrode layer 13 using sputtering and then by forming a desired pattern using an etching method.

Finally, after a portion of the substrate layer 15b of the support layer 15 is removed by DRIE, a portion of the middle layer 15a is removed by RIE. As a result, as illustrated in FIG. 2, the cavity 101 is provided, and the plurality of beam portions 120 and connection portions 130 are formed. In the process described above, the transducer 100 according to embodiment 1 of the present disclosure as illustrated in FIGS. 1 to 3 is manufactured.

Here, the following will describe the results of a simulation analysis of an internal stress generated during deformation in a turn-around portion of a connection portion according to an example with the dividing slit and a turn-around portion of a connection portion according to a comparative example without a dividing slit.

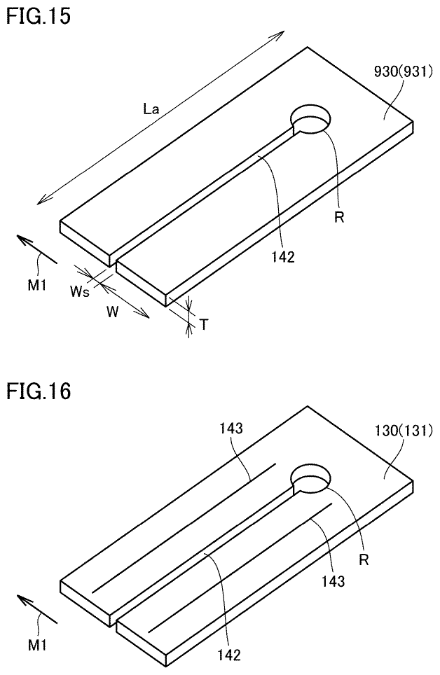

FIG. 15 is a diagram for describing a state in which a load in the in-plane direction is applied to one end of the turn-around portion of the connection portion according to the comparative example and deformation occurs. FIG. 16 is a diagram for describing a state in which a load in the in-plane direction is applied to one end of the turn-around portion of the connection portion according to the example and deformation occurs.

As illustrated in FIGS. 15 and 16, in the shapes of a turn-around portion 931 of a connection portion 930 according to the comparative example and a turn-around portion 131 of the connection portion 130 according to the example, the dimension of a width W is 7 μm, the dimension of a length La of 35 μm, the dimension of a width Ws of the second slit 142 of 1 μm, the dimension of the diameter of an R portion at an end of the second slit 142 is 4 μm, the dimension of the thickness is 1.6 μm, the dimension of the length of the dividing slit 143 is 28 μm, and the dimension of the width of the dividing slit 143 is 0.1 μm. The material constituting the connection portion 930 and the connection portion 130 is single-crystal Si.

In the turn-around portion 931 of the connection portion 930 according to the comparative example and the turn-around portion 131 of the connection portion 130 according to the example, the second end is displaced by 5 μm by a load M1 in the in-plane direction being applied to the second end on the left side in the drawing while the first end on the right side in the drawing is fixed.

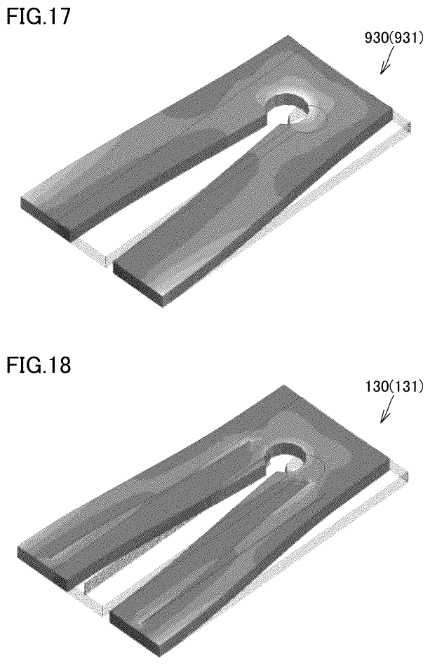

FIG. 17 is a diagram illustrating the distribution of an internal stress generated in a state in which a load in the in-plane direction is applied to one end of the turn-around portion of the connection portion according to the comparative example and deformation has occurred. FIG. 18 is a diagram illustrating the distribution of an internal stress generated in a state in which a load in the in-plane direction is applied to one end of the turn-around portion of the connection portion according to the example and deformation has occurred. In FIGS. 17 and 18, the color becomes lighter as the internal stress increases.

As illustrated in FIGS. 17 and 18, the internal stress generated during deformation in the turn-around portion 131 of the connection portion 130 according to the example is lower than that in the turn-around portion 931 of the connection portion 930 according to the comparative example. That is, since the turn-around portion 131 of the connection portion 130 according to the example has the dividing slits 143, the connection portion 130 has a lower rigidity in the in-plane direction and is likely to deform in the in-plane direction.

When the pair of beam portions 120 connected by the connection portion 130 is displaced by the same amount of displacement in the thickness direction (Z-axis direction) of the connection portion 130, a load is applied to the connection portion 130 so as to spread in the in-plane direction. In the connection portion 130 according to the example that is likely to deform in the in-plane direction, since deformation easily occurs due to application of a stress in the in-plane direction, the stress in the in-plane direction of the connection portion 130 can be relieved such that the displacement of the pair of beam portions 120 in the Z-axis direction are not excessively hindered.

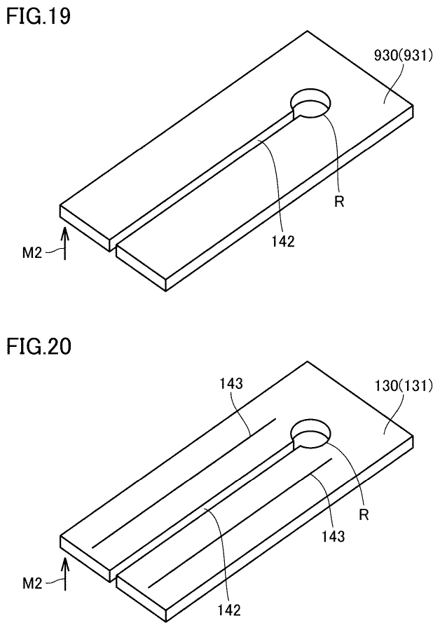

FIG. 19 is a diagram for describing a state in which a load in the thickness direction is applied to one end of the turn-around portion of the connection portion according to the comparative example and deformation occurs. FIG. 20 is a diagram for describing a state in which a load in the thickness direction is applied to one end of the turn-around portion of the connection portion according to the example and deformation occurs.

In the turn-around portion 931 of the connection portion 930 according to the comparative example and the turn-around portion 131 of the connection portion 130 according to the example, the second end is displaced by 5 μm by a load M2 in the thickness direction (Z-axis direction) being applied to the second end on the left side in the drawing while the first end on the right side in the drawing is fixed.

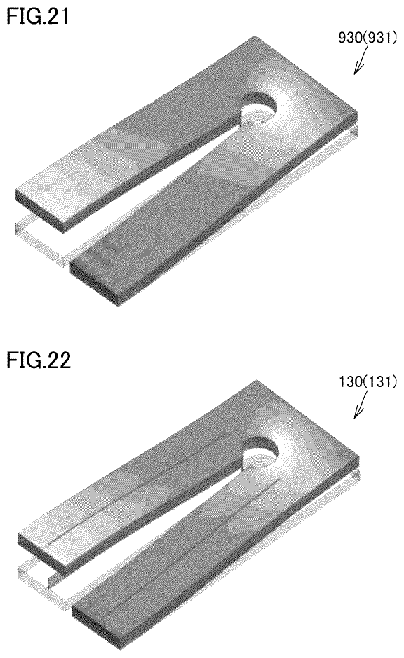

FIG. 21 is a diagram illustrating the distribution of an internal stress generated in a state in which a load in the thickness direction is applied to one end of the turn-around portion of the connection portion according to the comparative example and deformation has occurred. FIG. 22 is a diagram illustrating the distribution of an internal stress generated in a state in which a load in the thickness direction is applied to one end of the turn-around portion of the connection portion according to the example and deformation has occurred. In FIGS. 21 and 22, the color becomes lighter as the internal stress increases.

As illustrated in FIGS. 21 and 22, the internal stress generated during deformation is substantially the same between the turn-around portion 931 of the connection portion 930 according to the comparative example and the turn-around portion 131 of the connection portion 130 according to the example. That is, similar to the turn-around portion 931 of the connection portion 930 according to the comparative example, the turn-around portion 131 of the connection portion 130 according to the example maintains the rigidity of the connection portion 130 in the thickness direction even though the dividing slits 143 are formed.

When the pair of beam portions 120 connected by the connection portion 130 is displaced by different amounts of displacement in the same direction of the thickness direction (Z-axis direction) of the connection portion 130, or when the pair of beam portions 120 is displaced in the opposite directions of the thickness direction (Z-axis direction) of the connection portion 130, a load is applied to the connection portion 130 so as to spread in the thickness direction. Since the connection portion 130 according to the example maintains the rigidity in the thickness direction of the connection portion 130 and has a large deformation resistance, the vibration deviation of the pair of beam portions 120 can be effectively suppressed to reduce the difference in the amount of displacement in the Z-axis direction of the pair of beam portions 120.

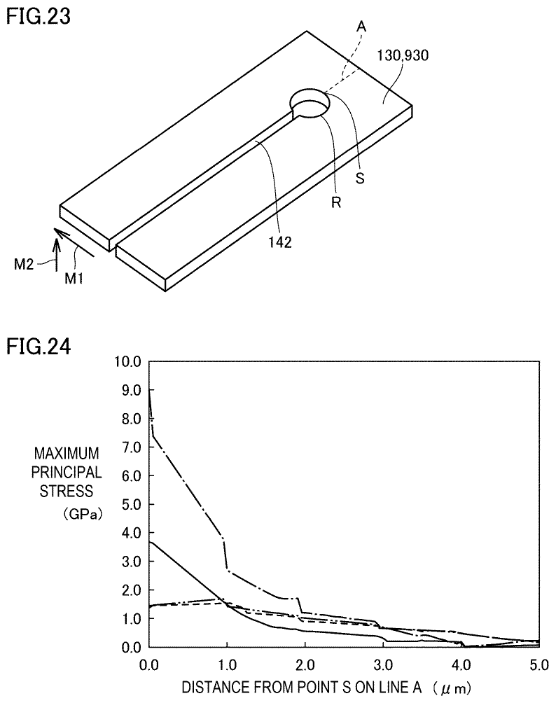

FIG. 23 is a diagram for describing the distributions of internal stresses generated in the turn-around portions of the connection portions according to the comparative example and the example. As illustrated in FIG. 23, in the connection portions 930 and 130 according to the comparative example and the example, a simulation analysis of the distribution of the maximum principal stresses generated along line A located on an extension of the second slit 142 was made.

FIG. 24 is a graph illustrating changes in the maximum principal stress with respect to the distance from point S at the root of portion R on line A. In FIG. 24, the vertical axis represents the maximum principal stress (GPa), and the horizontal axis represents the distance (μm) from point S on line A. The solid line indicates the data when the load M1 in the in-plane direction is applied to the connection portion 130 according to the example, the dash-dot line indicates the data when the load M1 in the in-plane direction is applied to the connection portion 930 according to the comparative example, the dotted line indicates the data when the load M2 in the thickness direction is applied to the connection portion 130 according to the example, and the dash-dot-dot line indicates the data when the load M2 in the thickness direction is applied to the connection portion 930 according to the comparative example.

As illustrated in FIG. 24, the maximum principal stress during deformation in the in-plane direction in the connection portion 130 according to the example was significantly reduced because the dividing slit 143 is formed as compared with that in the connection portion 930 according to the comparative example. On the other hand, the maximum principal stress generated during deformation in the thickness direction was substantially the same between the connection portion 930 according to the comparative example and the connection portion 130 according to the example.

In accordance with the results described above, in the transducer 100 according to embodiment 1 of the present disclosure, by enabling the adjustment of the rigidity in the in-plane direction (XY direction) and the rigidity in the thickness direction (Z-axis direction) of the connection portion 130 as appropriate, the vibration deviation of the plurality of beam portions 120 can be effectively suppressed while the stress in the in-plane direction of the connection portion 130 is relieved by the connection portion 130 and the vibrations of the beam portions 120 are not excessively hindered. When the dividing slit 143 is formed in this manner, the design flexibility of the transducer 100 can be improved, and the redundancy of the design of the transducer 100 can be improved.

Since the transducer 100 according to the embodiment includes the connection portion 130 having the structure described above, vibration in the fundamental vibration mode is likely to occur, and the occurrence of the coupled vibration mode is suppressed. Accordingly, when the transducer 100 is used as an ultrasonic transducer, even if ultrasonic waves that have the same frequency component as the resonant frequency are detected, the phases of the vibrations of the plurality of beam portions 120 are suppressed from differing from each other. Eventually, the electric charges generated in the piezoelectric body layers 11 of the plurality of beam portions 120 are suppressed from being cancelled each other in the first electrode layer 12 or the second electrode layer 13 due to the difference in the phases of the vibrations of the plurality of beam portions 120. As described above, the transducer 100 has improved device characteristics as an ultrasonic transducer.

In addition, the dividing slit 143 divides, substantially evenly, the portion of the connection portion 130 that the dividing slit 143 partially branches. Since this can uniform the distribution of an internal stress generated during deformation of the connection portion 130, the connection portion 130 can have a robust structure.

In addition, the two dividing slits 143 that extend parallel to each other with a gap therebetween may be formed to branch a portion of the connection portion 130 into three by the two dividing slits 143. This can further improve the design flexibility of the transducer 100.

It should be noted that the second slit 142 does not necessarily have to pass through the connection portion 130. In this case, sound leakage through the second slits 142 can be effectively suppressed.

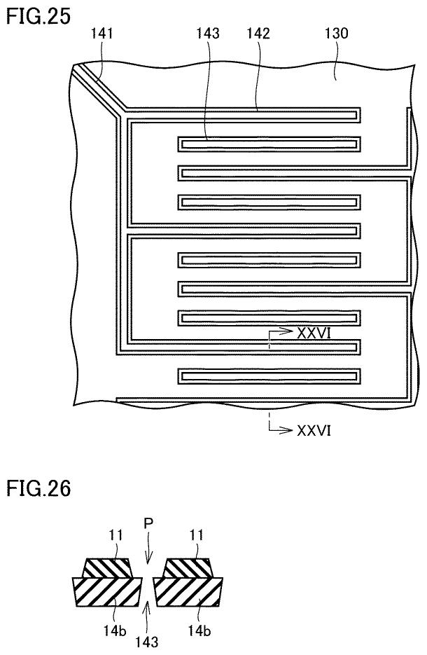

FIG. 25 is a plan view illustrating, in an enlarged manner, a portion of the connection portion including the second elastic body layer that functions as the lower electrode layer and the piezoelectric body layer. FIG. 26 is a cross-sectional view of the connection portion in FIG. 25 as viewed in an XXVI-XXVI direction. As illustrated in FIGS. 25 and 26, the connection portion 130 may be formed of the second elastic body layer 14b, made of low-resistance Si, that functions as the lower electrode layer and the piezoelectric body layer 11 laminated on the second elastic body layer 14b. In this case, the dividing slit 143 is formed by forming a slit P with a desired width in the piezoelectric body layer 11 located on the second elastic body layer 14b and forming a slit in the second elastic body layer 14b. The dividing slit 143 can also be formed in the same manner even when a layer other than the piezoelectric body layer 11 is further laminated on the second elastic body layer 14b.

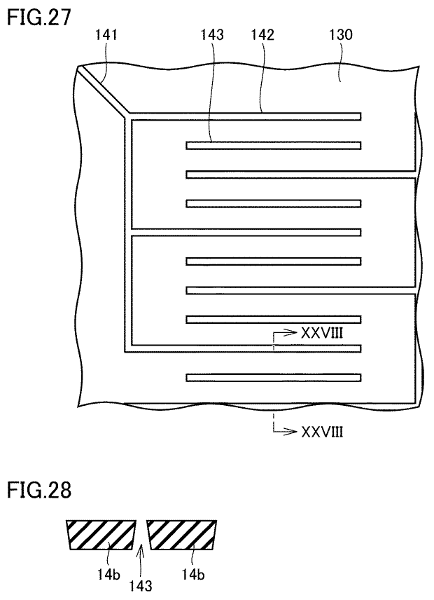

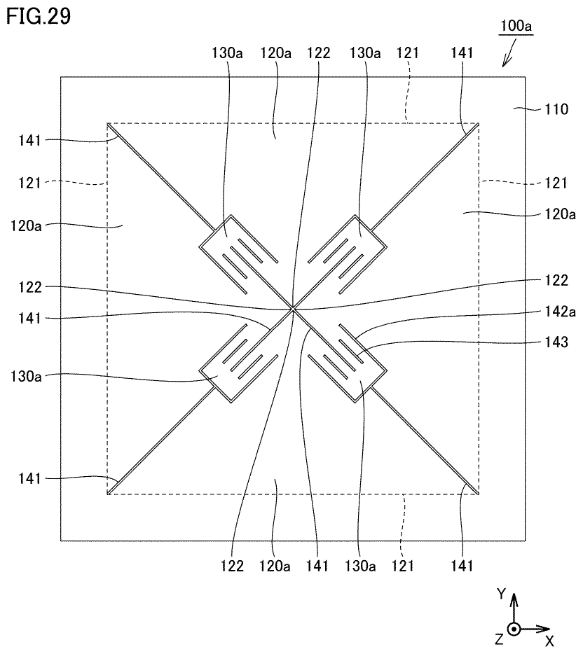

FIG. 27 is a plan view illustrating a portion of the connection portion including only the second elastic body layer in an enlarged manner. FIG. 28 is a cross-sectional view of the connection portion in FIG. 27 as viewed in an XXVIII-XXVIII direction. As illustrated in FIGS. 27 and 28, the connection portion 130 may include only the second elastic body layer 14b. In this case, the connection portion 130 can be easily formed.

FIG. 29 is a plan view of a transducer according to a first modification of embodiment 1 of the present disclosure. As illustrated in FIG. 29, a second slit 142a is formed in a U-shape in the transducer 100a according to the first modification of embodiment 1 of the present disclosure, and accordingly, the connection portion 130a has one turn-around portion. Each of the plurality of beam portions 120a is connected at one location to one connection portion 130a.

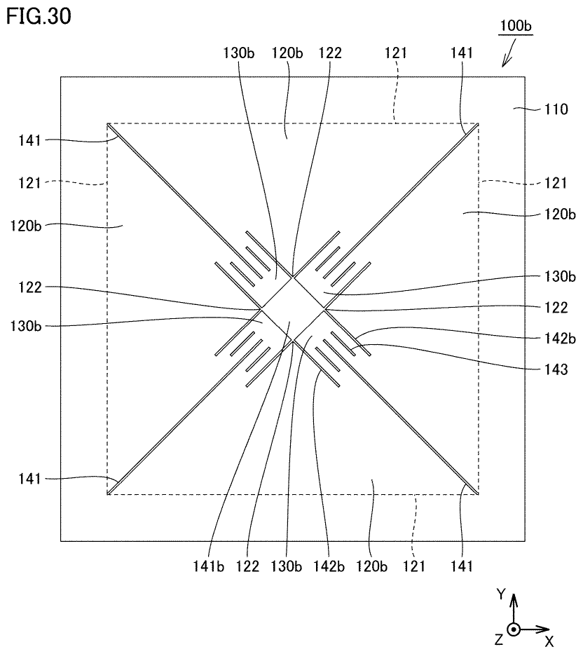

FIG. 30 is a plan view of a transducer according to a second modification of embodiment 1 of the present disclosure. As illustrated in FIG. 30, in the transducer 100b according to the second modification of embodiment 1 of the present disclosure, a square opening 141b is formed at the central position of the base portion 110 in the vibration layer 10 as viewed in the central axis direction (Z-axis direction). Since a pair of second slits 142b extends in a direction parallel to the first slit 141 from corner portions of the opening 141b so as to put a portion of the first slit 141 therebetween, a connection portion 130b has one turn-around portion. Each of the plurality of beam portions 120b is connected at one location to one connection portion 130b.

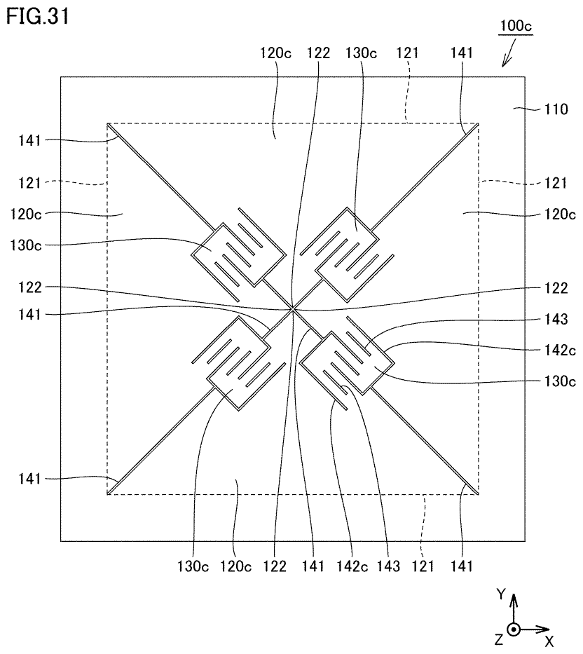

FIG. 31 is a plan view of a transducer according to a third modification of embodiment 1 of the present disclosure. As illustrated in FIG. 31, since second slits 142c are formed in a pair of U-shapes combined with each other in a transducer 100c according to the third modification of embodiment 1 of the present disclosure, a connection portion 130c has two turn-around portions. Each of a plurality of beam portions 120c is connected at one location to one connection portion 130c.

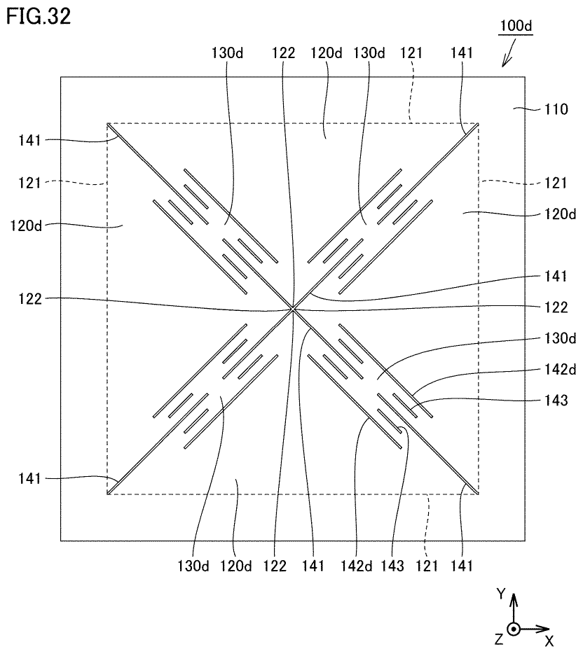

FIG. 32 is a plan view of a transducer according to a fourth modification of embodiment 1 of the present disclosure. As illustrated in FIG. 32, in a transducer 100d according to the fourth modification of embodiment 1 of the present disclosure, since a pair of second slits 142d is formed to extend in a direction parallel to the first slit 141 as viewed in the central axis direction (Z-axis direction) so as to put a portion of the first slit 141 therebetween, a connection portion 130d has an H-shape. Each of a plurality of beam portions 120d is connected at two locations to one connection portion 130d.

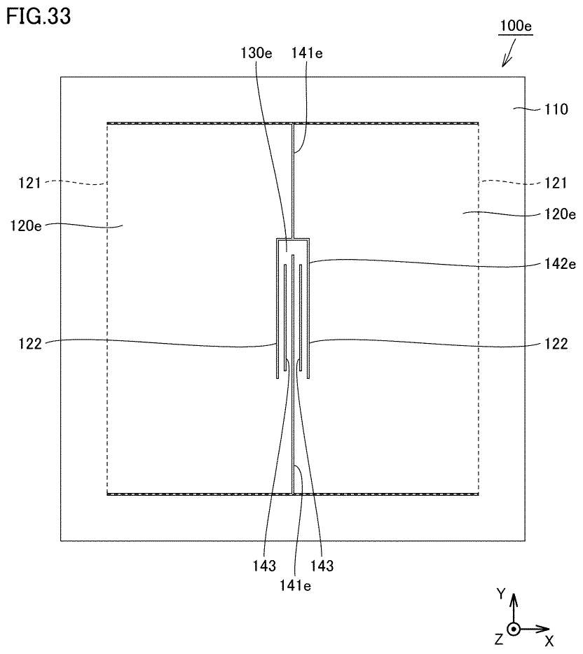

FIG. 33 is a plan view of a transducer according to a fifth modification of embodiment 1 of the present disclosure. As illustrated in FIG. 33, a transducer 100e according to the fifth modification of embodiment 1 of the present disclosure includes two rectangular beam portions 120e as viewed in the central axis direction (Z-axis direction). A first slit 141e extends from the midpoint of the two sides on the inner surface of the base portion 110 toward the center of the base portion 110 as viewed in the central axis direction (Z-axis direction). Since a second slit 142e is formed in a U-shape, a connection portion 130e has one turn-around portion. Each of the plurality of beam portions 120e is connected at one location to one connection portion 130e.

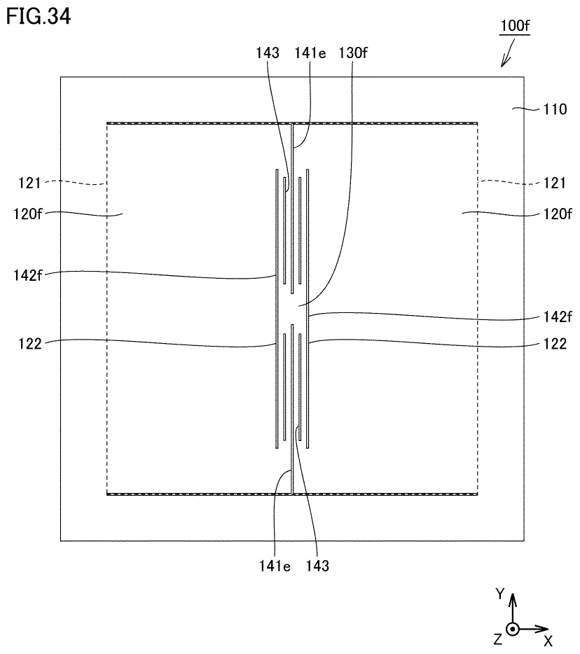

FIG. 34 is a plan view of a transducer according to a sixth modification of embodiment 1 of the present disclosure. As illustrated in FIG. 34, a transducer 100f according to the sixth modification of embodiment 1 of the present disclosure includes two rectangular beam portions 120f as viewed in the central axis direction (Z-axis direction). Since a pair of second slits 142f is formed to extend in a direction parallel to the first slit 141e as viewed in the central axis direction (Z-axis direction) so as to put a portion of the first slit 141e therebetween, a connection portion 130f has an H-shape. Each of the plurality of beam portions 120f is connected at two locations to one connection portion 130f.

Also in the transducers 100a to 100f according to the first to sixth modifications described above, by enabling the adjustment of the rigidity in the in-plane direction (XY direction) and the rigidity in the thickness direction (Z-axis direction) of the connection portions 130a to 130f as appropriate, the vibration deviation of the plurality of beam portions 120a to 120f can be effectively suppressed while the stresses in the in-plane direction of the connection portions 130a to 130f are relieved by the connection portions 130a to 130f and the vibrations of the beam portions 120a to 120f are not excessively hindered.

### Embodiment 2

A transducer according to embodiment 2 of the present disclosure will be described below with reference to the drawings. The transducer according to embodiment 2 of the present disclosure differs from the transducer according to embodiment 1 in that a common connection portion is formed at the center of the base portion, and the structure that is the same as that of the transducer according to embodiment 1 will not be described.

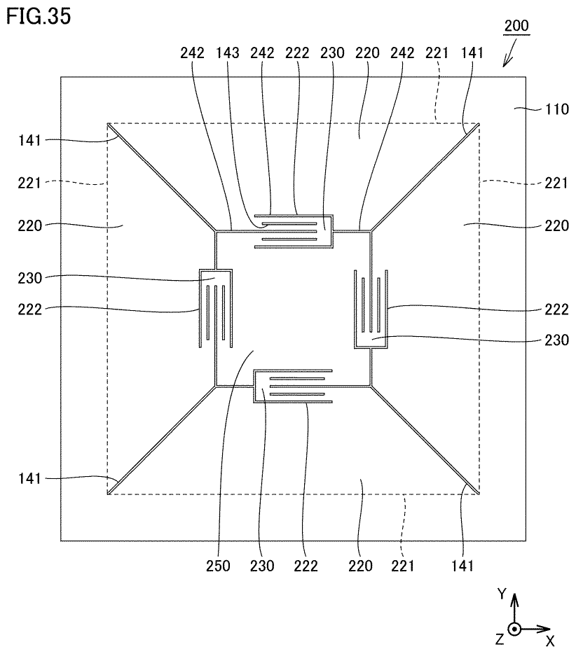

FIG. 35 is a plan view of the transducer according to embodiment 2 of the present disclosure. As illustrated in FIG. 35, a transducer 200 according to embodiment 2 of the present disclosure includes a base portion 110, a plurality of beam portions 220, a connection portion 230, and a common connection portion 250. In the embodiment, the transducer 200 includes four beam portions 220. A second slit 242 is formed in a square shape formed by sides each having a U-shaped portion and includes four connection portions 230 each having one turn-around portion and the common connection portion 250, connected to the four connection portions 230, that has a substantially square shape. Each of the plurality of beam portions 220 is connected at one location to one connection portion 230. Each of the four connection portions 230 is connected at one location to the common connection portion 250.

A pair of beam portions 220 adjacent to each other in the peripheral direction of the base portion 110 of the plurality of beam portions 220 is connected to each other by the two connection portions 230 and the common connection portion 250.

Also in the transducer 200 according to embodiment 2 of the present disclosure, by enabling the adjustment of the rigidity in the in-plane direction (XY direction) and the rigidity in the thickness direction (Z-axis direction) of the connection portion 230 as appropriate, the vibration deviation of the plurality of beam portions 220 can be effectively suppressed while the stress in the in-plane direction of the connection portion 230 is relieved by the connection portion 230 and the vibrations of the beam portions 220 are not excessively hindered.

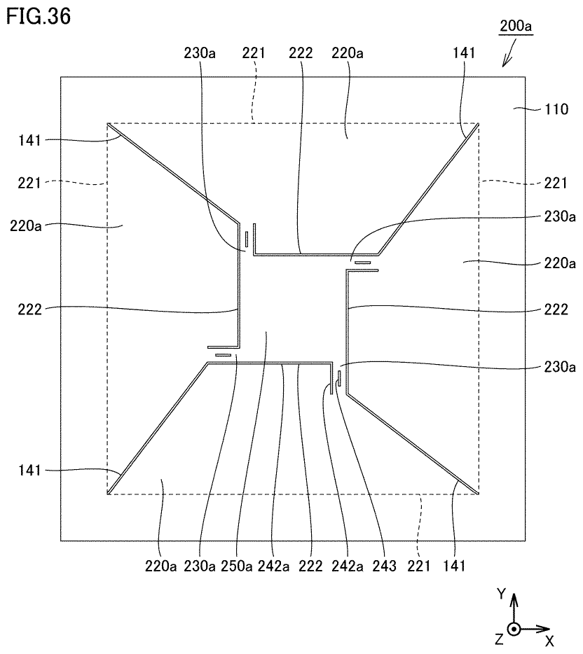

FIG. 36 is a plan view of a transducer according to a modification of embodiment 2 of the present disclosure. As illustrated in FIG. 36, in a transducer 200a according to the modification of embodiment 2 of the present disclosure, a second slit 242a is formed in a square shape with L-shaped portions on individual sides and includes four connection portions 230a that extend linearly and a substantially square common connection portion 250a connected to the four connection portions 230a. Each of the plurality of beam portions 220a is connected at one location to one connection portion 230a. Each of the four connection portions 230a is connected at one location to the common connection portion 250a.

A pair of beam portions 220a adjacent to each other in the peripheral direction of the base portion 110 of the plurality of beam portions 220a is connected to each other by two connection portions 230a having extension directions that differ from each other by 90° and the common connection portion 250a. That is, the two connection portions 230a and the common connection portion 250a constitute one bent portion.

Also in the transducer 200a according to embodiment 2 of the present disclosure, by enabling the adjustment of the rigidity in the in-plane direction (XY direction) and the rigidity in the thickness direction (Z-axis direction) of the connection portion 230a as appropriate, the vibration deviations of the plurality of beam portions 220a can be effectively suppressed while the stress in the in-plane direction of the connection portion 230a are relieved by the connection portion 230a and the vibrations of the beam portions 220a are not excessively hindered.

### Embodiment 3

A transducer according to embodiment 3 of the present disclosure will be described below with reference to the drawings. The transducer according to embodiment 3 of the present disclosure differs from the transducer according to embodiment 1 in that the dividing slit partially branches the connection portion in the thickness direction, and the structure that is the same as that of the transducer according to embodiment 1 will not be described.

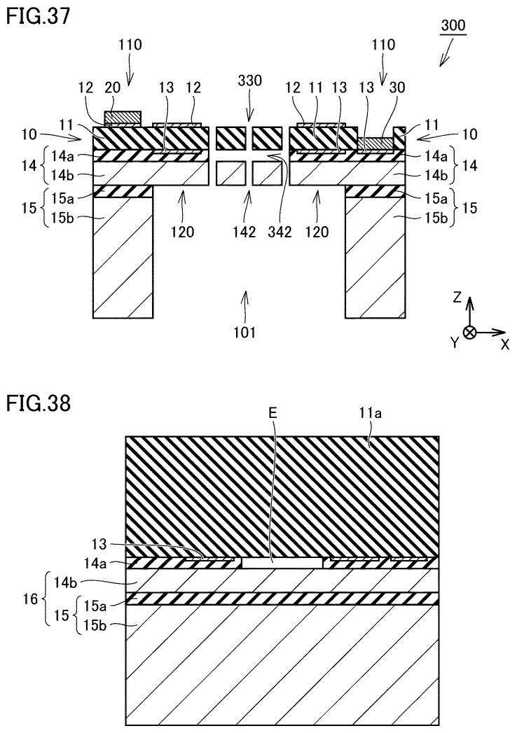

FIG. 37 is a cross-sectional view of the transducer according to embodiment 3 of the present disclosure. In FIG. 37, the same cross-sectional view as in FIG. 2 is illustrated. As illustrated in FIG. 37, in the transducer 300 according to embodiment 3 of the present disclosure, a dividing slit 342 passes through the connection portion 330 in the in-plane direction (XY direction) orthogonal to the thickness direction (Z-axis direction) of the connection portion 330 and partially branches the connection portion 330 in the thickness direction (Z-axis direction).

Only the difference between the manufacturing method of the transducer 300 according to embodiment 3 of the present disclosure and the manufacturing method of the transducer 100 according to embodiment 1 will be described below.

FIG. 38 is a cross-sectional view illustrating a state in which the multilayer body has been joined to the first support portion in a manufacturing method of the transducer according to embodiment 2 of the present disclosure. As illustrated in FIG. 38, after the lower surface of the first elastic body layer 14a is ground and flattened, a portion of the first elastic body layer 14a at location E corresponding to the formation position of the dividing slit 342 is removed. After that, the multilayer body 16 including the second elastic body layer 14b and the support layer 15 is joined to the lower surface of the first elastic body layer 14a by surface activation bonding or atomic diffusion bonding. The subsequent process is the same as that of the manufacturing method of the transducer 100 according to embodiment 1. It should be noted that a similar structure can be obtained by a sacrificial layer made of ZnO or the like being embedded in the location E in advance and the sacrificial layer being removed ultimately.

In the process described above, as illustrated in FIG. 37, the dividing slit 342 is formed between the piezoelectric body layer 11 and the second elastic body layer 14b in the connection portion 330.

In the transducer 300 according to embodiment 3 of the present disclosure, since the connection portion 330 is partially branched in the thickness direction (Z-axis direction) by the dividing slit 342, the connection portion 330 has a lower rigidity in the thickness direction (Z-axis direction) and is likely to deform in the thickness direction (Z-axis direction). On the one hand, the rigidity of the connection portion 330 in the in-plane direction is maintained. As a result, the displacement deviation of the pair of beam portions 120 in the in-plane direction can be effectively suppressed while the stress in the thickness direction (Z-axis direction) of the connection portion 330 is relieved and the displacement of the pair of beam portions 120 in the Z-axis direction is not excessively hindered.

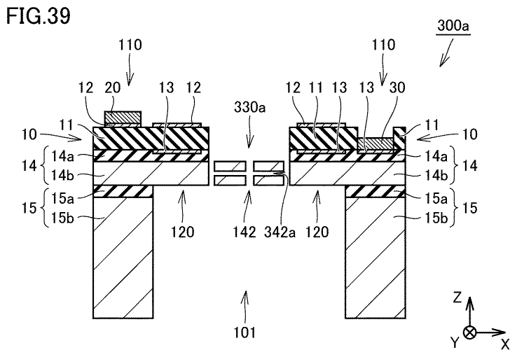

FIG. 39 is a cross-sectional view of a transducer according to a modification of embodiment 3 of the present disclosure. As illustrated in FIG. 39, a transducer 300a according to the modification of embodiment 3 of the present disclosure has a dividing slit 342a formed in the second elastic body layer 14b in a connection portion 330a.

In the modification, for example, the second elastic body layer 14b is formed by two-stage deposition. At this time, the dividing slit 342a can be formed by a sacrificial layer made of ZnO or the like being embedded in the location E corresponding to the formation position of the dividing slit 342a in advance and the sacrificial layer being removed ultimately.

In the modification, in the portion of the connection portion 330a partially branched in the thickness direction (Z-axis direction), both of branched portions include the same material. This can improve the design flexibility of the transducer 300.

The dividing slit 342a divides, substantially evenly, the portion of the connection portion 330a that the dividing slit 342a partially branches. As a result, the distribution of an internal stress generated during deformation of the connection portion 330a can be uniformed, and accordingly, the connection portion 330a can have a robust structure.

In the descriptions of the embodiments above, combinable structures may be combined with each other.

The embodiments disclosed here should be considered illustrative in all respects and not restrictive. The scope of the present disclosure is indicated not by the descriptions above but by the claims, and the scope includes all changes within the meaning and the range equivalent to the claims.

### REFERENCE SIGNS LIST

10 vibration layer
11 piezoelectric body layer
11a single-crystal substrate
12 first electrode layer
13 second electrode layer
14 elastic body layer
14a first elastic body layer
14b second elastic body layer
15 support layer
15a middle layer
15b substrate layer
16 multilayer body
17 groove portion
18 recessed portion
20 first connection electrode layer
30 second connection electrode layer
100, 100a, 100b, 100c, 100d, 100e, 100f, 200, 200a, 300, 300a, transducer
101 cavity
110 base portion
120, 120a, 120b, 120c, 120d, 120e, 120f, 220, 220a, beam portion
121 fixed end portion
122 crest portion
130, 130a, 130b, 130c, 130d, 130e, 130f, 230, 230a, 330, 330a, 930, connection portion
131, 931 turn-around portion
141, 141e first slit
141b opening
142, 142a, 142b, 142c, 142d, 142e, 142f, 242, 242a second slit
143, 342, 342a dividing slit
250, 250a common connection portion
C central axis

1. A transducer comprising:
a base portion;
a plurality of beam portions each having a fixed end portion connected to the base portion and a crest portion located close to a center of the base portion on a side thereof opposite to the fixed end portion, the plurality of beam portions each extending from the fixed end portion toward the crest portion; and
a connection portion that connects a pair of beam portions of the plurality of beam portions to each other, the pair of beam portions being adjacent to each other in a peripheral direction of the base portion,
wherein the connection portion includes:
at least one bent portion, and
at least one dividing slit in the connection portion, the at least one dividing slit dividing the connection portion such that the connection portion is partially branched and rejoined.

2. The transducer according to claim 1, wherein each of the plurality of beam portions is a vibrating portion including a piezoelectric body layer.

3. The transducer according to claim 1, wherein the at least one dividing slit passes through the connection portion in the thickness direction of the connection portion and partially branches the connection portion in an in-plane direction.

4. The transducer according to claim 3, wherein the at least one dividing slit divides a portion of the connection portion that the at least one dividing slit partially branches.

5. The transducer according to claim 1, wherein the at least one dividing slit passes through the connection portion in an in-plane direction orthogonal to the thickness direction and partially branches the connection portion in the thickness direction.

6. The transducer according to claim 5, wherein the at least one dividing slit divides a portion of the connection portion that the at least one dividing slit partially branches.

7. The transducer according to claim 5, wherein, in a portion of the connection portion partially branched in the thickness direction, branched portions of the connection portion include the same material.

8. The transducer according to claim 1, wherein each of the plurality of beam portions is connected at two locations to the connection portion.

9. The transducer according to claim 1,
wherein the at least one dividing slit includes two dividing slits that extend parallel to each other with a space therebetween, and
a portion of the connection portion is branched into three by the two dividing slits.

10. The transducer according to claim 1, wherein the base portion includes a support layer that defines a cavity which overlaps with the crest portion of the plurality of beam portions in a thickness direction of plurality of beam portions.

11. The transducer according to claim 1, wherein a width dimension of the dividing slit is 10 μm or less.

12. The transducer according to claim 1, wherein the connection portion has a meandering shape with a plurality of turn-around portions, and each of the turn-around portions includes two of the bent portions.

13. The transducer according to claim 1, wherein the connection portion has one turn-around portion.

14. The transducer according to claim 1, wherein the plurality of beam portions define an opening at the center of the base portion.

15. The transducer according to claim 1, wherein the connection portion has an H-shape.

16. The transducer according to claim 1, wherein connection portion has a meandering shape.
